(19) United States
(12) Patent Application Publication
(10) Pub. No.: US 2025/0187861 A1
(43) Pub. Date: Jun. 12, 2025

(54) DEVICE COMPACT ROLL STAND FOR FLEXIBLE MATERIAL COILS

(71) Applicant: MEKATRONICA MX S.A.S., Bogota (CO)

(72) Inventors: Luis Albeiro Rodriguez Cadena, Bogota (CO); Luis Alejandro Rodriguez Luna, Blacksburg, VA (US)

(73) Assignee: MEKATRONICA MX S.A.S., Bogota (CO)

(21) Appl. No.: 18/682,964

(22) PCT Filed: Jun. 28, 2022
(86) PCT No.: PCT/IB2022/055999

§ 371 Date: Feb. 12, 2024

(30) Foreign Application Priority Data
Aug. 10, 2021 (CO) NC2021/0010489

(51) Int. Cl. B65H 16/02

(52) U.S. Cl. CPC B65H 16/02; B65H 2801/81

(57) ABSTRACT

A device compact roll stand for coils that allows two rolls of material (coils) to be simultaneously incorporated, for feeding systems that process and package different products, especially thermoformed products (polypropylene, polystyrene, high barrier, and PET materials). It has a safety system, cutting bench, and access mechanism for handling by the personnel responsible for the same, it can be transported, and it allows spaces in the industrial sector to be optimized and the feeding process of the flexible material to continue, without having to stall the operation or pause the packaging for long periods of time due to the swapping and replacement of the rolls of material.

### CROSS REFERENCE TO RELATED APPLICATION

This application is a National Stage Entry of PCT/IB2022/055999 filed Jun. 28, 2022, under the International Convention and claiming priority over Colombian Patent Application No. NC2021/0010489 filed Aug. 10, 2021.

### TECHNOLOGICAL FIELD

The present invention is related to industrial devices for packaging products from mechanical systems fed with coils of flexible or laminated material. Particularly, those used for thermoforming and in general plastic injection machines, which require rolls of material such as polypropylene, polystyrene, high barrier materials, in a linear and sequential form; It is also related to the industrial methods for the transport and assembly of such devices.

### BACKGROUND OF THE INVENTION

In the technological sector of the food industry mainly, and especially in food packaging processes, it is imperative to use flexible materials that serve as a protective barrier, in order to guarantee the innocuousness of its characteristics.

Within the aforementioned technological sector, thermoforming machines, and in general plastic injection molding machines, usually require a large physical structure of about 9m2 to dispose of the rolls of material (polypropylene, polystyrene, high barrier materials, pet) in a linear and sequential way. For its operation they need an operator with a forklift to raise the roll of material to include it in a horizontal surface or rotating shaft and every time the flexible material on the roll runs out, it must be replaced by a new one, which implies stopping the machine completely, gluing each coil, removing the shaft of the roll to be replaced, lifting it, pushing the new roll that is in the back, feeding the machine and loading the new roll in the back and then, activating the machine again.

With this process, in addition to the space required to maneuver properly, time is lost and there are constant interruptions to the industrial production activity; at least it must be suspended for a period of 15 minutes to replace the flexible material, approximately 16 times for every 24 hours of production on average, in addition to operational errors and the need to perform constant suspension to adjust the system and the rolls of material.

Additionally, the device used in the industry requires an available area of more than 9m2 for its operation and its corresponding free areas to carry out the assembly/disassembly of the rolls and this is excessive in an industrial scenario.

Another option available in the market is to configure the plants to condition a tandem loading system, which implies a considerable investment, more space in the plant, longer logistic times, and the suspension of the operation to fix the roll in the thermoforming machine.

Thus, the compact roll stand system for coils presents a more efficient, economical, and functional alternative for the food production industry, which reduces interruptions to production processes while maximizing the work area in the plants by its vertical arrangement and allows continuity in the supply of flexible material for thermoforming and plastic injection machines.

### SUMMARY OF THE INVENTION

The device compact roll stand for coils that allows the incorporation of two rolls of material (coils) simultaneously, for feeding processing and packaging systems of different products, especially thermoformed (polypropylene, polystyrene, high barrier materials and PET), with security system, cutting table and access mechanism for maneuverability of the personnel responsible for it, transportable and that allows the optimization of spaces in an industrial setting and the continuity of the flexible material feeding process, without the need to suspend the operation or interrupt for considerable periods of time the packaging due to the change and replacement of the rolls of material.

The system is composed of a main tubular structure, divided into two cross sections that facilitate its transportation, maintenance and assembly, sections that are joined by means of a system of high resistance pins that guarantee structural stability.

The main metal structure has a surface fixing system that provides the stability required for the roll material to circulate fluidly without vibrations or movements that put the operation at risk. The structure was validated with its dynamic and static loads, and breaking points were evident, oversizing the weight, with this the torsions were detected, and calculations were made for its proper functioning.

The front part includes safety bars that keep the tubular structure protected from possible contact by the forklift used to load the rolls of flexible material, whose weight ranges between 1 and 1.5 tons.

The device has a lateral access ladder, which allows the operator to check the operation at both levels (lower and upper), without having to suspend the operation as happens with current systems (horizontal).

In the upper part of the modular system, a reinforced protection basket is included, whose purpose is to serve as a protective barrier in case of irregular movements that could displace the axis of the structure, in order to preserve the thermoforming equipment and personnel. that is around the device.

The device has two levels for feeding rolls of material; the lower level and the upper level, each of them includes a tubular shaft that supports the roll of material and allows its rotation to feed the thermoforming equipment. The tubular shaft are located in a “u” support made of compact and replaceable plastic material that reduces friction, prevents the generation of contaminating residues in the packaged materials (normally caused by including bronze parts) and guarantees the rotation of the axle in the where the rolls of material rest.

The system has an extension piece in the upper section of the “u” support created to prevent the shaft from being thrown out in the event of any sudden movement. This piece is adjusted once the roll of material has been included in the shaft of the upper section. The system includes guide rollers that help keep the material being dispensed aligned.

The device integrates a cutting table with a slot designed for the use of the safety scalpel by the operator, with which the operator can safely cut the flexible material.

The device is equipped, on the same side as the side access ladder, a system of additional supports for storing the roll replacement shafts, which are available at any time.

The device is equipped with a functional disassembly system to facilitate its transportation in containers to allow up to 4 devices to be introduced simultaneously in a single container.

The device is equipped with a special piece designed for on-site assembly of the equipment, whose purpose is to join the two cross sections that make up the tubular structure and assemble it, guaranteeing the required firmness and support.

### BRIEF DESCRIPTION OF THE FIGURES

FIG. 1 shows the main structure (1001) incorporating all the elements that make up the systems of the invention.

FIG. 2 shows the bumpers (1002) included for the protection of the structure used in the present invention.

FIG. 3 shows the safety supports for rollers (1003) included in the invention.

FIG. 4 shows the sliding sheets (1004) located at the bottom of the device.

FIG. 5 shows the cutting table (1005).

FIG. 6 shows the roller (3.5.1) that complements the cutting table.

FIG. 7 shows the location of the sheets (3.5.2) on the cutting table (1005).

FIG. 8 shows the lower protection rubbers (1006).

FIG. 9 shows the upper protection system.

FIG. 10 shows the threading rollers (1007) and the upper threading roller in detail.

FIG. 11 shows the main measurements of the bearing.

FIG. 12 shows the fixed shaft support (1008).

FIG. 13 shows the shaft supports with caps (1009).

FIG. 14 shows the plastic supports (3.9.1).

FIG. 15 shows the anti-wear caps (3.9.2).

FIG. 16 shows the heat gun holder (1010).

FIG. 17 shows the hammer holder (1011).

### DETAILED DESCRIPTION OF THE INVENTION

The device compact roll stand for coils consists of the following systems: a main structure (1001), a bumper system (1002), safety support for rollers (1003), sliding sheet system (1004), cutting table (1005), crash protection rubber (1006), threading rollers (1007), fixed axle support (1008), axle support with caps (1009), heat gun support (1010) and hammer support (1011).

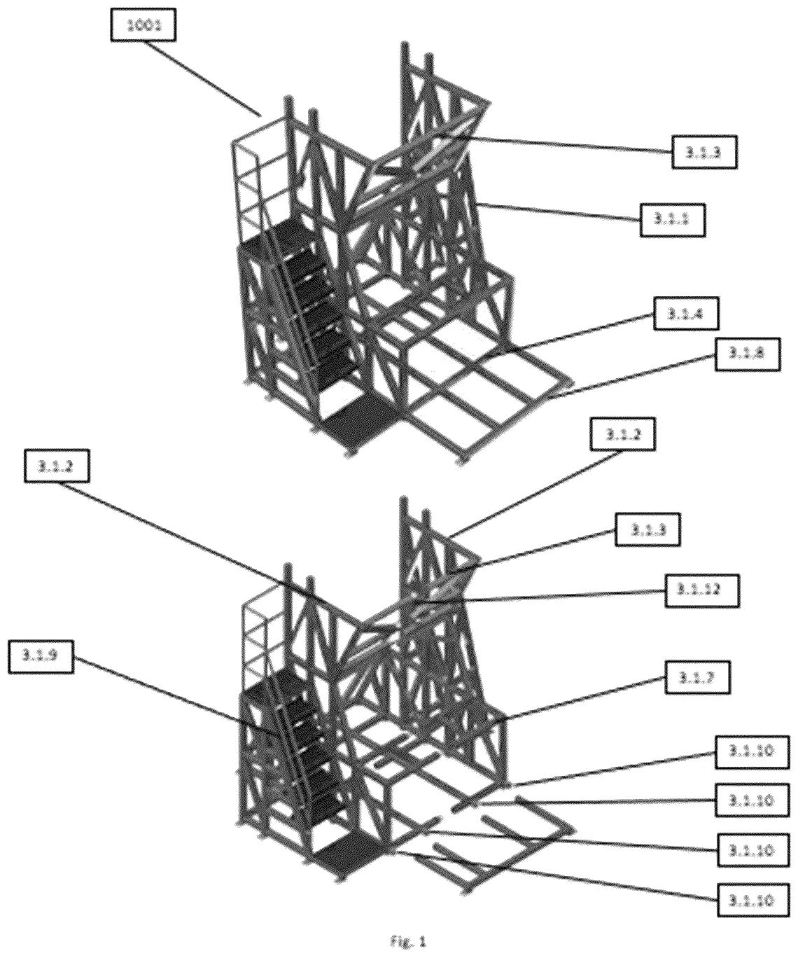

The present device compact roll stand for coils includes a main structure (1001) (FIG. 1) on which each of the systems that compose it are supported in each of its corresponding places. It is designed to support up to 4 tons of weight, it is divided into three parts, due to ease of installation and is made up of the following elements; a lateral reinforcement (3.1.1) responsible for preventing the structure from overturning on its left side due to overloads or lateral impacts; a lateral structure (3.1.2) responsible for supporting the vertical loads exerted by the rollers; an upper horizontal structure (3.1.3) whose function is to prevent the loads of the upper rollers from opening the structure; a lower horizontal structure (3.1.4) that supports the lower sliding sheets, preventing the sinking of these sheets when the material passes; a cutting table structure (3.1.7) is responsible for serving as support for the sheets that make up the cutting table, allowing firmness when making cuts in the flexible material; an outer tray structure (3.1.8) is responsible for preventing the plastic sheet from coming into contact with the ground, before and after the sheets of each roller are joined on the cutting table; a ladder (3.1.9) whose function is to allow the operator to climb to the required height without a harness, in order to receive the axles that are already without available sheet; a structural union (3.1.10) made up of eleven (11) blocks of solid 1020 steel which not only joins the two sides, but is responsible for reinforcing this union; a lower structural joint (3.1.11) that is joined to the general structure by means of (4) four 1020 steel blocks, they are welded to the general structure and bolted to the outer tray; and some joints (3.1.12) made up of sheets that are responsible for covering the joints in the structure. The roll stand has four units of these sheets, and they are located in the upper part of the main structure.

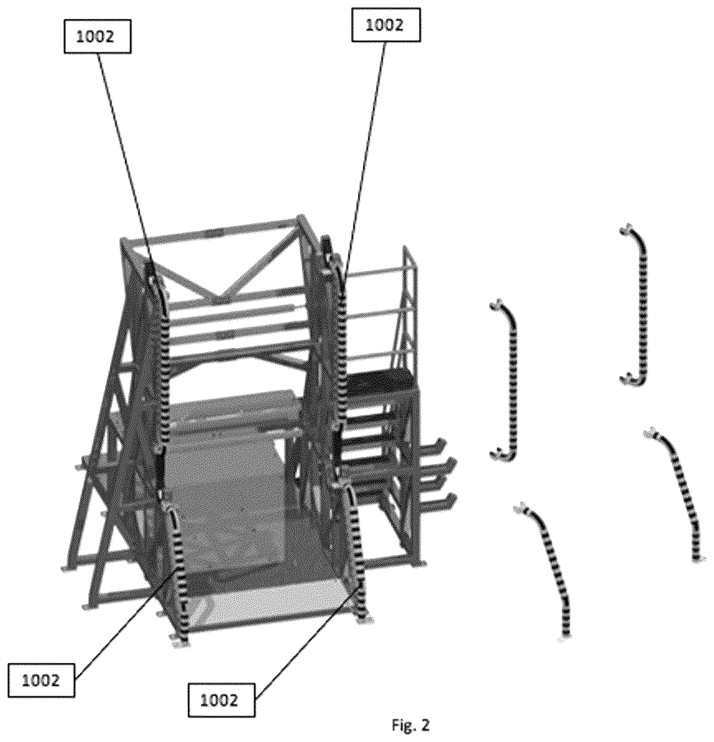

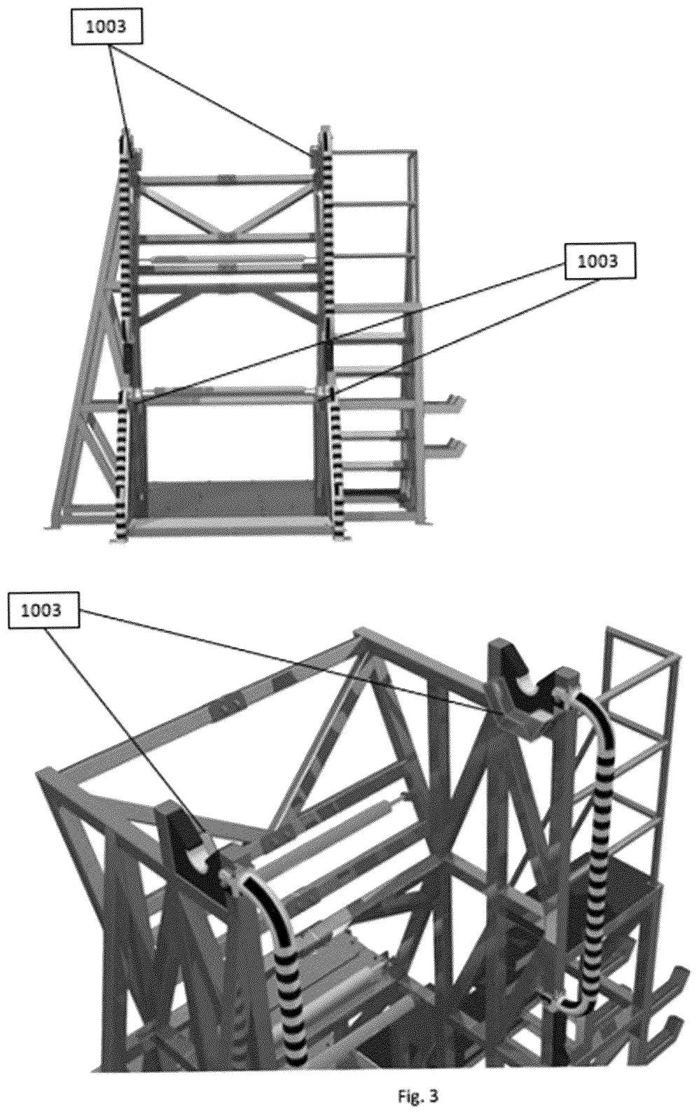

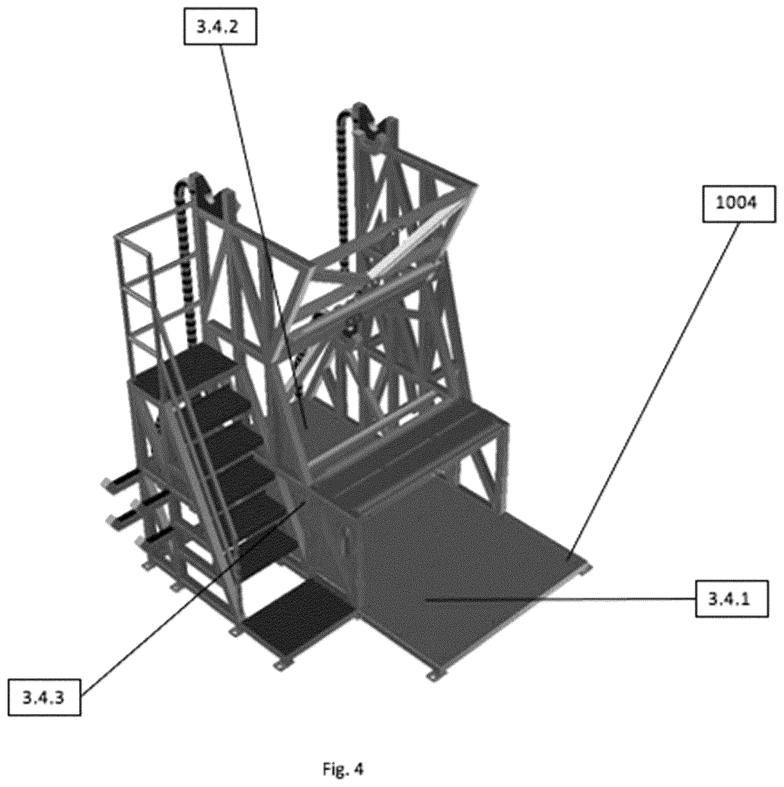

The present device compact roll stand for coils includes a bumper system (1002) (FIG. 2) made up of structural arms that protect the main structure from impacts caused by forklifts when loading the coils to the roll stand, preventing any damage to the roll stand of its mechanical resistance; a safety support for rollers (1003) (FIG. 3) responsible for supporting half of the weight of the shaft together with the coils, in case they fall from the main supports, preventing accidents, they are made of square steel tube of 60 mm×60 mm carbon and are welded together with each of the supports with bushings; a system of sliding sheets (1004) (FIG. 4) are located at the bottom of the device, whose function is to allow the plastic sheet to slide, through a satin finish, without generating any damage to the plastic sheet, which made of 18 gauge AISI 304 stainless steel; this system (1004) is made up of three (3) sheets, due to the commercial format of the sheet, and that the joints of the sheets are supported on structural members, these sheets are: lower structure sheet (3.4.1), upper horizontal sheet (3.4.2) and lower intermediate sheet (3.4.3).

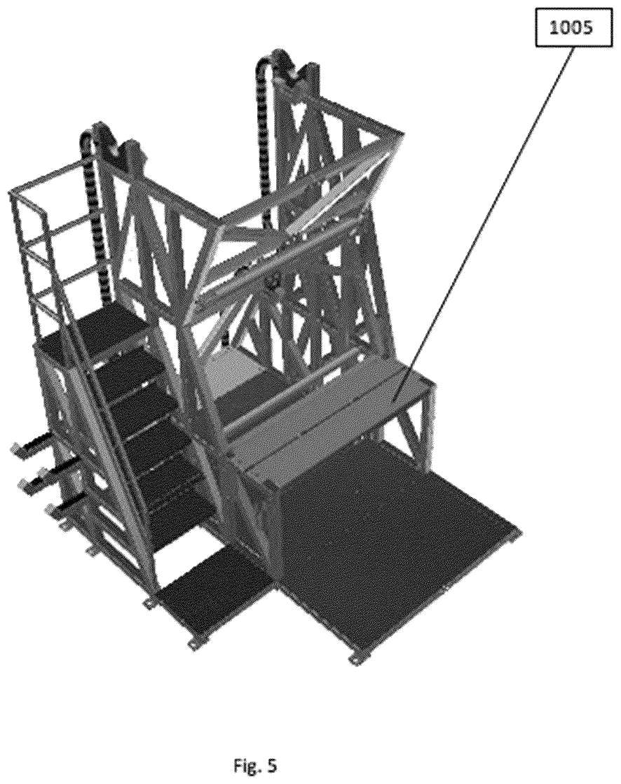

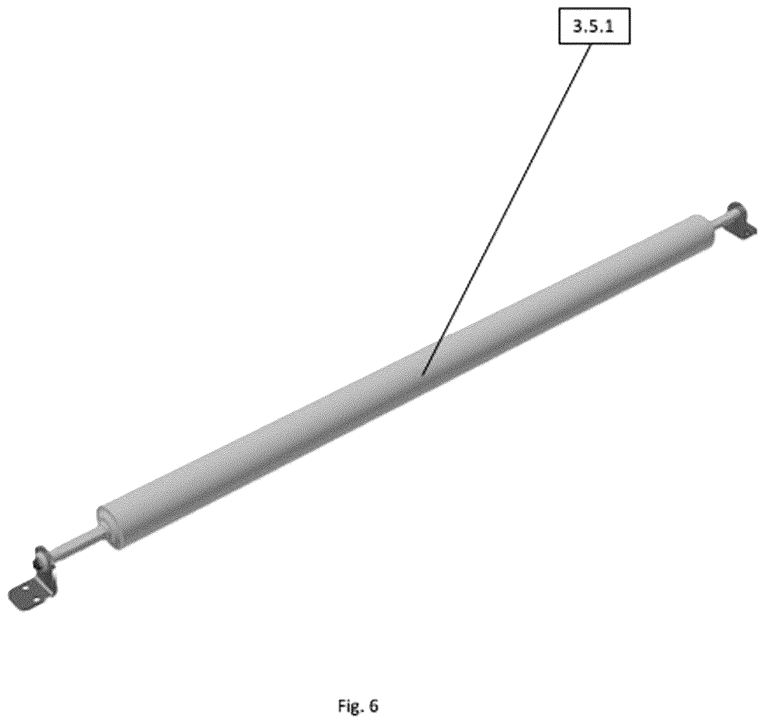

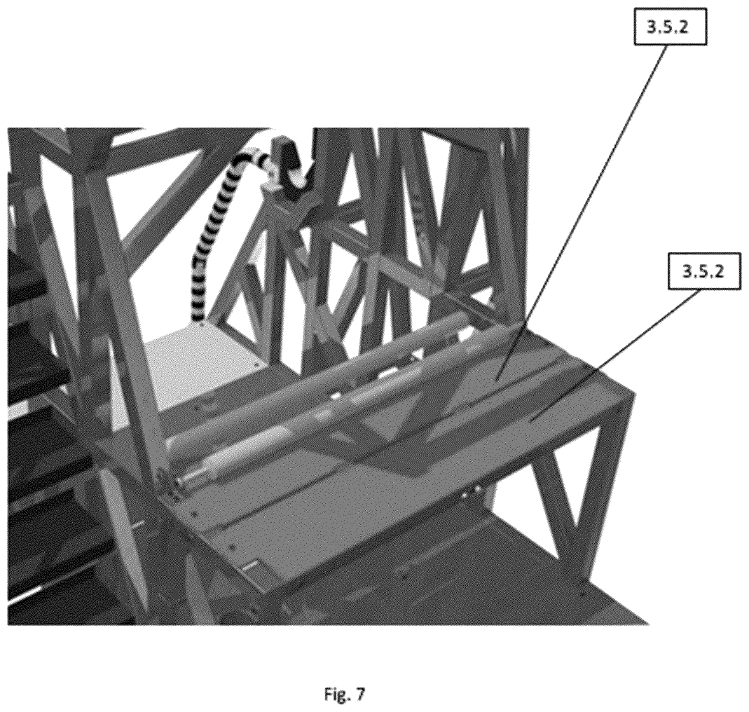

The present device compact roll stand for coils is characterized by including a cutting table system (1005) (FIG. 5) whose purpose is to allow the operator to join two sheets of flexible material by means of the application of heat, simultaneously with the review of several times a roller that joins the sheets, which makes it easier to cut the material straight thanks to the groove found in the center for easy joining, this table is also made up of a threading roller (1007). The cutting table (1005) is made up of a cutting table roller (3.5.1) (FIG. 6) which is in charge of introducing the sheet into the cutting table in such a way that the sheets coming from the upper or lower roller have to pass through it to make it easy to cut and join the plastic sheets; two stainless steel sheets (3.5.2) (FIG. 7) which, when placed in place, leave a groove open enough to pass a scalpel cutting the ends of the sheets coming out of the coil, leaving them straight, leaving them in a straight line. the ends of the sheets coming out of the coil, leaving them straight.

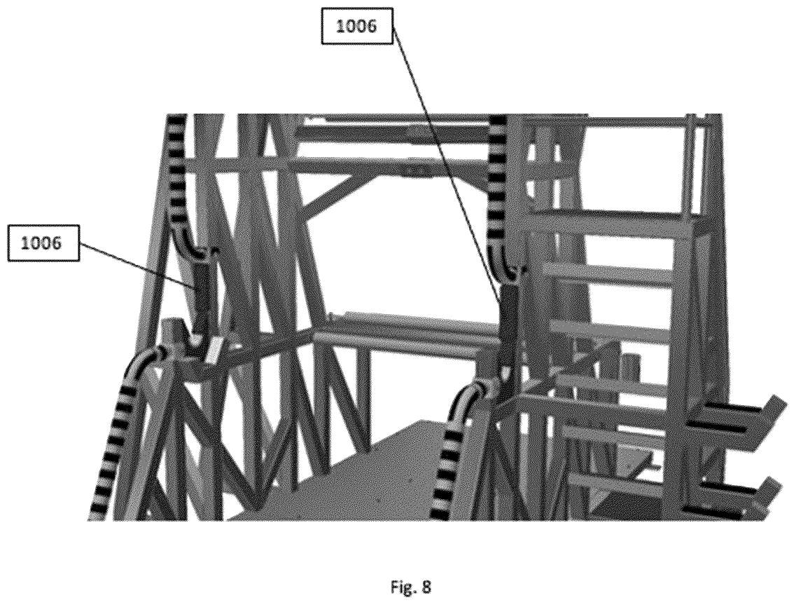

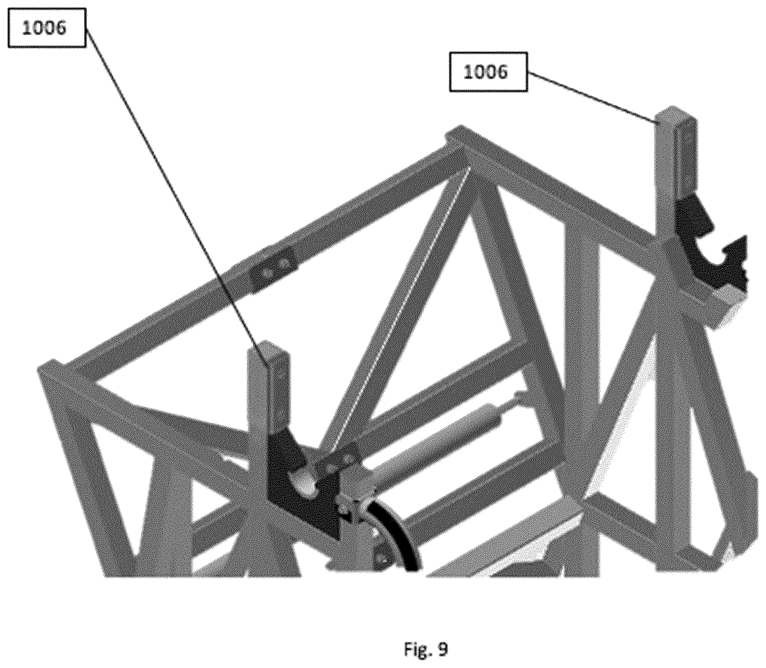

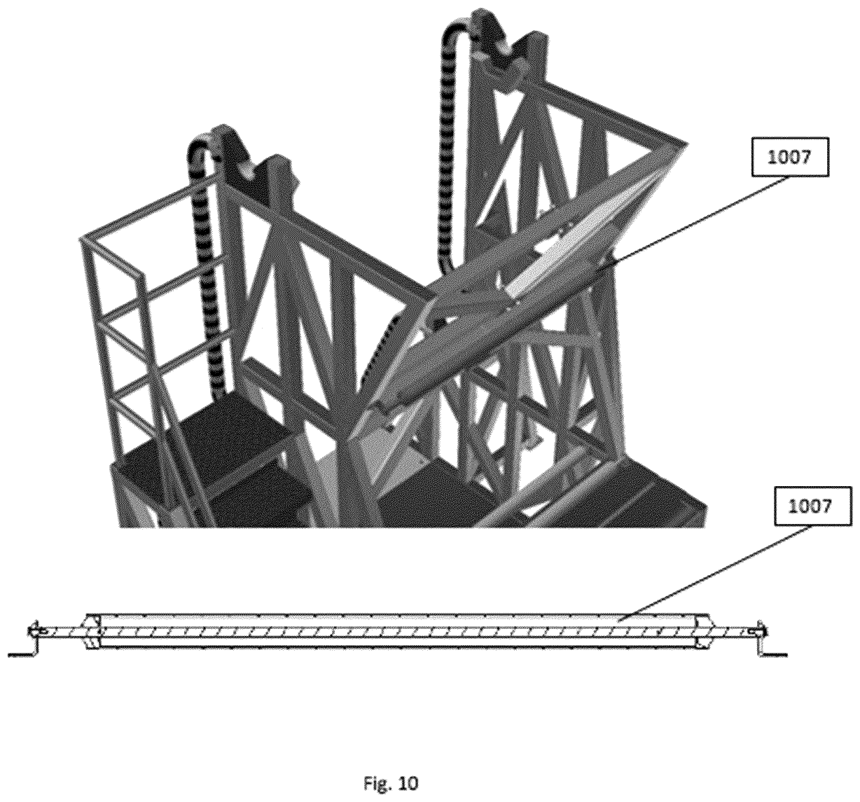

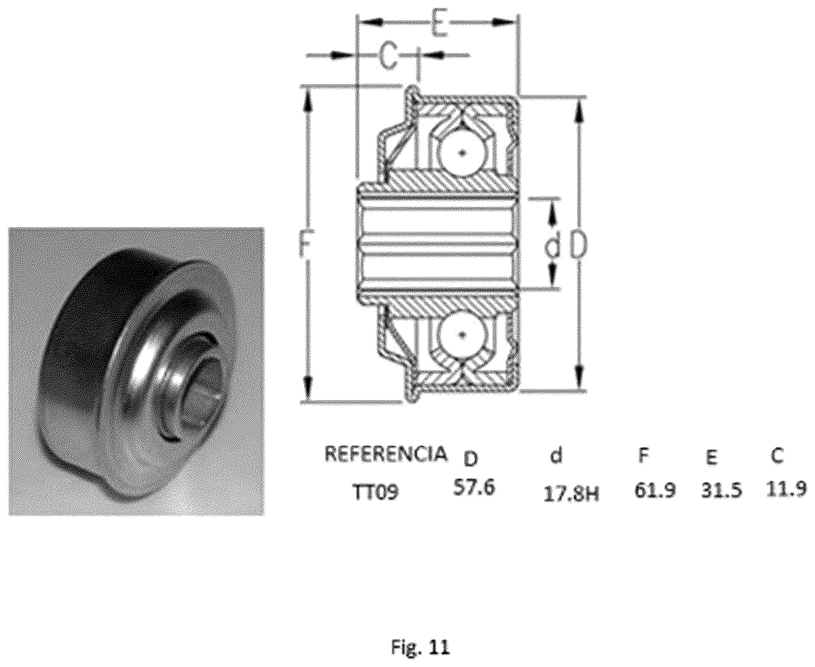

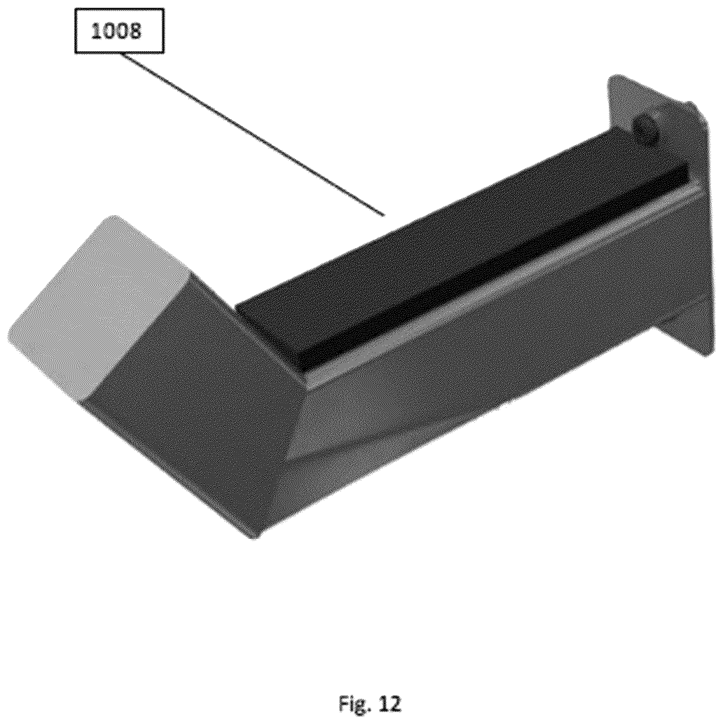

This device compact roll stand for coils is characterized by including a system of shock protection rubber (1006) (FIG. 8) that protects the main structure (1001) from direct blows when positioning the shaft within the supports with bushings; these are located at the top of the structure (FIG. 9), and at the bottom, just below the bumpers; and a system of threading rollers (1007) (FIG. 10) that has the function of entering the plastic sheet into the cutting table, in this case the threading rollers allow it to exit the plastic sheet of the coil and enter the roller of the cutting table, of these rollers there are two types, the upper threading roller and the lower threading roller, each one intended for one of the rollers loaded in the system; the threading rollers are composed of a hexagonal carbon steel shaft with a distance between faces of 11/16″, into which a roller bearing ref.: TT09 (FIG. 11) fits. The device includes a fixed axle support (1008) where the rollers rest when they no longer have a coil, at the side of the ladder, this support consists of two arms each at 120° in square tube of 60×60 Cal 12, on these supports rests a plastic sheet in UHMW that prevents the shafts from hitting (FIG. 12).

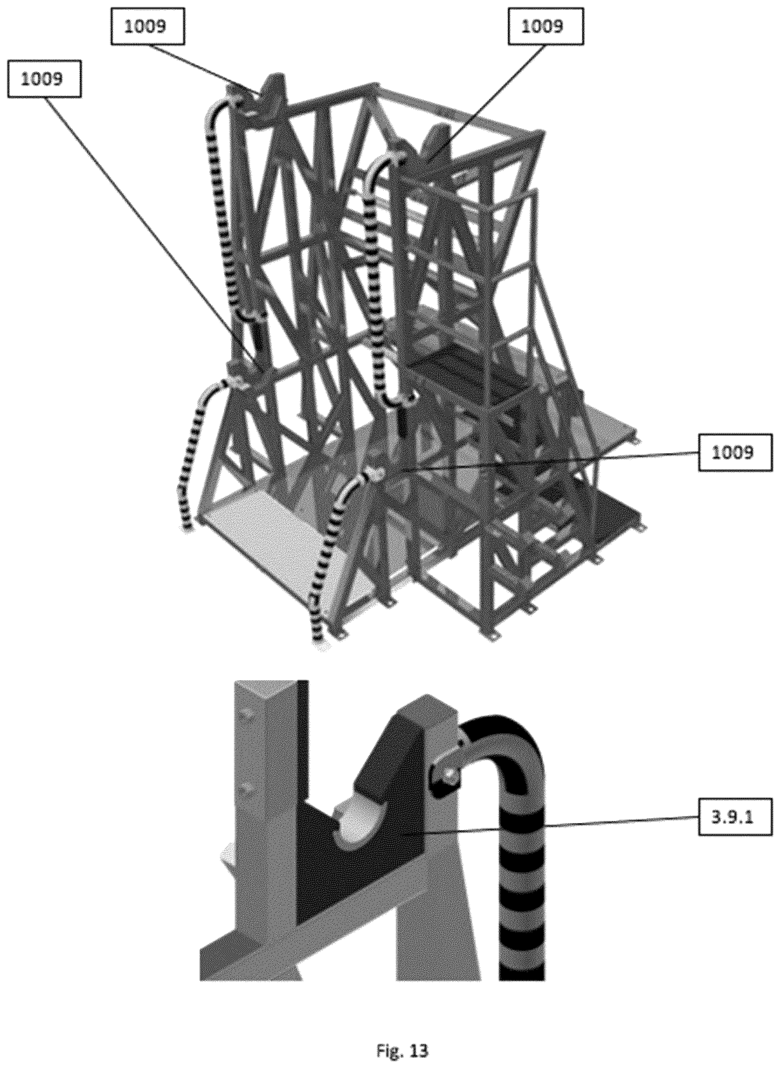

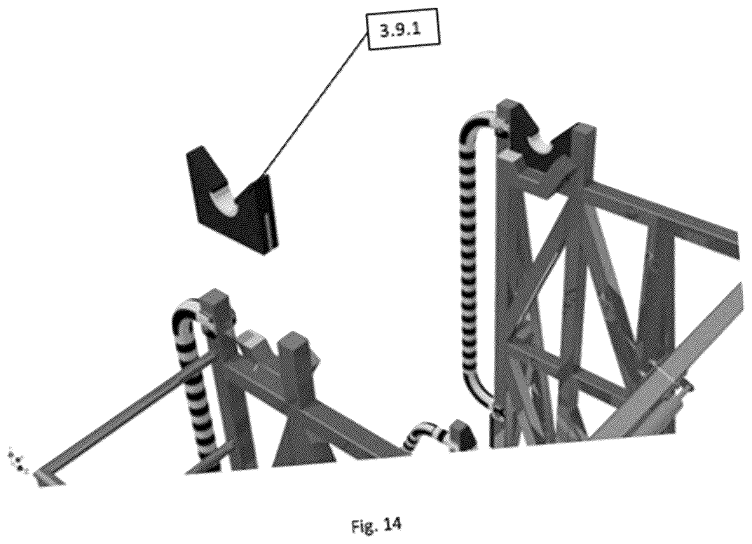

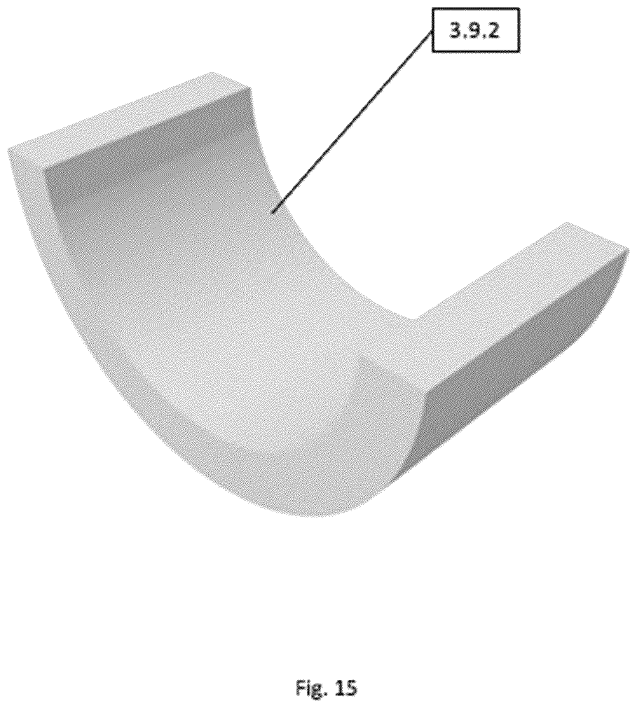

The present device compact roll stand for coils is characterized by including a shaft support with caps (1009) (FIG. 13) that supports the coils while the sheet is unrolled, supporting not only the load of 1.5 tons of weight of each roller, but also resists the wear that occurs when the coil and shaft rotate. This support is made up of a plastic support (3.9.1) responsible for resisting the load of the weight of the rollers, without adding much weight to the structure and serves as cushioning, when an axle for some reason impacts this area, it distributes the load throughout. along the support and prevents the load from being very punctual, increasing the stress supported by the structure. The plastic support (3.9.1) is made of an engineering plastic material called UHMW (Ultra High Molecular Weight) and is joined to the structure by means of two cradles which are welded to the structure, so the only way to disassembling it is by sliding it up (FIG. 14); the support also includes anti-wear caps (3.9.2) (FIG. 15) consisting of two crescents, made of engineering plastic (Nylon Moly) whose improved crystallization is produced by the addition of molybdenum disulfide. Includes MoS₂, which is a dry lubricant extremely effective. This also improves wear and abrasion resistance properties.

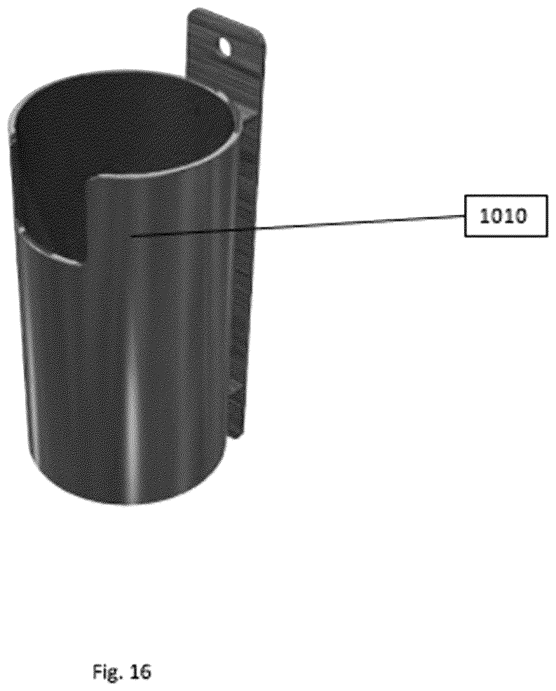

In addition, this compact roll stand device for coils includes a support for a heat gun (1010) (FIG. 16) which is located on the side of the cutting table (1005), right at the beginning of the stairs (3.1.9), is responsible for allowing the operator to rest the heat gun safely, because it is made of stainless steel, it does not contain paint or any flammable agent. This support has no bottom, the reason for this is that the heat from the gun is not stored, but dispersed with the environment, this way the gun does not suffer damage when stored.

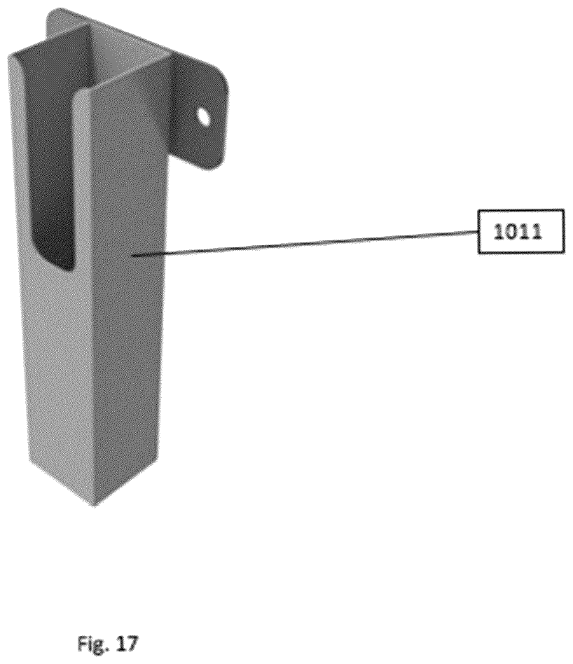

This device compact roll stand for coils is characterized by including a hammer support (1011) (FIG. 17), this element has a roller, which is responsible for applying a uniform force so that the sealing remains the same along the splice, this accessory, while not in use, is unloaded into the corresponding support, made of AISI 304 stainless steel, to withstand the wear caused by the handling of the hammer, this support has the particularity that at the bottom of it there is a perforation, the reason for this is that when carrying out maintenance tasks, any water or liquids that may fall into the support drain through this hole; this attachment rests right next to the heat gun support (1010).

1. A device compact roll stand for coils comprising:
A main structure system (1001);
A bumper system (1002);
A safety support for rollers (1003);
A sliding sheet system (1004);
A cutting table (1005);
A crash protection rubber (1006);
A threading roller system (1007);
A fixed axle support (1008);
A shaft support with caps (1009);
A heat gun support (1010); and
A hammer holder (1011).

2. The device according to claim 1, wherein the main structure (1001) is divided into three parts; a lateral reinforcement (3.1.1) responsible for preventing the structure from overturning on its left side due to overloads or lateral impacts; a lateral structure (3.1.2) responsible for supporting the vertical loads exerted by the rollers; an upper horizontal structure (3.1.3) to prevent the loads of the upper rollers from opening the structure; a lower horizontal structure (3.1.4) that supports the lower sliding sheets, preventing the sinking of these sheets when the material passes.

3. The device according to claim 1, further including a cutting table (3.1.7) for serving as support for the sheets that make up the cutting table, allowing firmness when making cuts in the material. flexible.

4. The device according to claim 1, wherein the outer tray structure (3.1.8) prevents the plastic sheet from coming into contact with the ground, before and after the sheets of each roller are joined in the cutting table.

5. The device according to claim 1, further including a ladder (3.1.9) to allow the operator to climb to the required height without a harness, to receive the axles that are already without available sheet.

6. The device according to claim 1, including a structural joint (3.1.10) made up of eleven (11) blocks of solid 1020 steel which not only joins the two sides, but is responsible for reinforcing the joint; a lower structural joint (3.1.11) that is joined to the general structure by four 1020 steel blocks welded to the general structure and bolted to the outer tray; and some joints (3.1.12) made up of sheets for covering the joints in the structure, the roll stand has four units of these sheets, and they are located in the upper part of the main structure.

7. The device according to claim 1, further including a safety support for rollers (1003) made of 60 mm×60 mm square carbon steel tube and are welded together with each of the supports with bushings.

8. The device according to claim 1, further including an axis support with caps (1009) to support the coils while the sheet is unrolled, composed of; a plastic support (3.9.1) responsible for resisting the load of the weight of the rollers joined by means of two cradles which are welded to the structure, including two anti-wear caps (3.9.2) consisting of two crescents, made of plastic engineering (Nylon Moly).

9. The device according to claim 1, further including a stainless-steel heat gun support (1010) without paint or any flammable agent, which is located on the side of the cutting table (1005).

10. The device according to claim 1, further including a stainless-steel hammer support (1011) having a bottom with a perforation, wherein when carrying out maintenance tasks, water or liquids that may fall into the support, drain through the perforation, a stainless-steel hammer support (1011) rests right next to the heat gun support (1010).
